(19) United States
(12) Patent Application Publication
(10) Pub. No.: US 2024/0174034 A1
(43) Pub. Date: May 30, 2024

(54) TIRE ROLLING RESISTANCE ESTIMATION SYSTEM

(71) Applicant: The Goodyear Tire & Rubber Company, Akron, OH (US)

(72) Inventors: Sanjay Raghav Balaga, Luxembourg (LU); Stefan Paul Köppen, Bitburg (DE); Kanwar Bharat Singh, Bofferdange (LU); Patrick Karen, Konz (DE)

(21) Appl. No.: 18/506,589

(22) Filed: Nov. 10, 2023

Related U.S. Application Data
(60) Provisional application No. 63/385,412, filed on Nov. 30, 2022.

(51) Int. Cl. B60C 23/04

(52) U.S. Cl. CPC B60C 23/0486; B60C 23/0484

(57) ABSTRACT

A tire rolling resistance estimation system estimates a real-time rolling resistance coefficient of a tire, and includes a tire sensor unit that measures a tire inflation pressure and a tire temperature. A processor is in electronic communication with the tire sensor unit. A steady state coefficient determination module in communication with the processor determines a steady state rolling resistance coefficient of the tire. A steady state tire temperature module in communication with the processor receives the steady state rolling resistance coefficient of the tire and estimates a steady state tire temperature of the tire. A real-time rolling resistance coefficient module in communication with the processor receives the steady state tire temperature of the tire and estimates a real-time rolling resistance coefficient of the tire from the steady state rolling resistance coefficient and a difference between the steady state tire temperature and a current tire temperature from the tire sensor unit.

### FIELD OF THE INVENTION

The invention relates generally to tire monitoring. More particularly, the invention relates to systems that monitor and estimate certain characteristics of a tire. Specifically, the invention is directed to a system that estimates the rolling resistance coefficient of a tire under transient driving or operating conditions.

### BACKGROUND OF THE INVENTION

Multiple tires support a vehicle, and transmit driving and braking forces from the vehicle to the road surface. It is often beneficial to estimate characteristics of a tire. One characteristic that is beneficial to estimate is the rolling resistance of a tire.

The rolling resistance of a tire is the amount of energy that is needed to enable the tire to roll over a surface. Estimation or prediction of tire rolling resistance is important, as it enables prediction of the driving range of a vehicle. Estimation of tire rolling resistance also enables prediction of energy loss, including fuel consumption for internal combustion engines and battery consumption for electric vehicles. In addition, estimates of tire rolling resistance are employed in force allocation determinations, which may be useful in braking and other control systems of the vehicle.

It is desirable to estimate the rolling resistance of a tire with the highest possible accuracy, but rolling resistance can be difficult to accurately predict, particularly in view of dynamic driving conditions. More particularly, the rolling resistance of a tire is a transient value or characteristic. As a tire is driven, its temperature generally increases, and rolling resistance changes as the tire temperature increases.

In the prior art, estimates of tire rolling resistance have been determined through rolling resistance lab testing or other controlled environments. However, it is difficult to extrapolate results from rolling resistance lab tests to accurately predict rolling resistance during dynamic driving conditions. For example, the ambient temperature in lab testing is often set at a fixed value, such as about 25 degrees Celsius. Prior art estimation techniques do not include an appropriate thermal model that accounts for tire temperature prediction during driving and tire warm-up.

As a result, there is a need in the art for a system that provides an accurate estimation of the rolling resistance of a tire under transient driving or operating conditions.

### SUMMARY OF THE INVENTION

According to an aspect of an exemplary embodiment of the invention, a tire rolling resistance estimation system is provided. The system estimates a real-time rolling resistance coefficient of a tire supporting a vehicle, and includes a tire sensor unit mounted to the tire, in which the tire sensor unit measures an inflation pressure of the tire and a temperature of the tire. A processor is in electronic communication with the tire sensor unit. A steady state coefficient determination module is in electronic communication with the processor, receives a plurality of inputs, and determines a steady state rolling resistance coefficient of the tire. A steady state tire temperature module is in electronic communication with the processor, receives the steady state rolling resistance coefficient of the tire from the steady state coefficient determination module, and estimates a steady state tire temperature of the tire. A real-time rolling resistance coefficient module is in electronic communication with the processor and receives the steady state tire temperature of the tire from the steady state tire temperature module. The real-time rolling resistance coefficient module estimates a real-time rolling resistance coefficient of the tire from the steady state rolling resistance coefficient and a difference between the steady state tire temperature and a current tire temperature from the tire sensor unit.

### BRIEF DESCRIPTION OF THE DRAWINGS

The invention will be described by way of example and with reference to the accompanying drawings, in which:

FIG. 1 is a schematic perspective view of a vehicle that includes a tire which employs an exemplary embodiment of a tire rolling resistance estimation system of the present invention;

FIG. 2 is a schematic representation of data transmission to a cloud-based server and to a device;

FIG. 3 is a schematic diagram of an exemplary embodiment of the tire rolling resistance estimation system of the present invention;

FIG. 4 is a graphical representation of an aspect of the exemplary embodiment of the tire rolling resistance estimation system shown in FIG. 3;

FIG. 5 is a graphical representation of another aspect of the exemplary embodiment of the tire rolling resistance estimation system shown in FIG. 3;

FIG. 6 is a graphical representation of another aspect of the exemplary embodiment of the tire rolling resistance estimation system shown in FIG. 3;

FIG. 7 is a graphical representation of another aspect of the exemplary embodiment of the tire rolling resistance estimation system shown in FIG. 3;

FIG. 8 is a graphical representation of another aspect of the exemplary embodiment of the tire rolling resistance estimation system shown in FIG. 3; and

FIG. 9 is a graphical representation of another aspect of the exemplary embodiment of the tire rolling resistance estimation system shown in FIG. 3.

Similar numerals refer to similar parts throughout the drawings.

### DEFINITIONS

“ANN” or “artificial neural network” is an adaptive tool for non-linear statistical data modeling that changes its structure based on external or internal information that flows through a network during a learning phase. ANN neural networks are non-linear statistical data modeling tools used to model complex relationships between inputs and outputs or to find patterns in data.

“Axial” and “axially” means lines or directions that are parallel to the axis of rotation of the tire.

“CAN bus” or “CAN bus system” is an abbreviation for controller area network system, which is a vehicle bus standard designed to allow microcontrollers and devices to communicate with each other within a vehicle without a host computer.

“Circumferential” means lines or directions extending along the perimeter of the surface of the annular tread perpendicular to the axial direction.

“Equatorial centerplane” means the plane perpendicular to the tire's axis of rotation and passing through the center of the tread.

“Footprint” means the contact patch or area of contact created by the tire tread with

a flat surface as the tire rotates or rolls.

“Inboard side” means the side of the tire nearest the vehicle when the tire is mounted on a wheel and the wheel is mounted on the vehicle.

“Lateral” means an axial direction.

“Lateral edges” means a line tangent to the axially outermost tread contact patch or footprint of the tire as measured under normal load and tire inflation, the lines being parallel to the equatorial centerplane.

“Net contact area” means the total area of ground contacting tread elements between the lateral edges around the entire circumference of the tread of the tire divided by the gross area of the entire tread between the lateral edges.

“Outboard side” means the side of the tire farthest away from the vehicle when the tire is mounted on a wheel and the wheel is mounted on the vehicle.

“Radial” and “radially” means directions radially toward or away from the axis of rotation of the tire.

“Rib” means a circumferentially extending strip of rubber on the tread which is defined by at least one circumferential groove and either a second such groove or a lateral edge, the strip being laterally undivided by full-depth grooves.

“Tread element” or “traction element” means a rib or a block element defined by a shape having adjacent grooves.

### DETAILED DESCRIPTION OF THE INVENTION

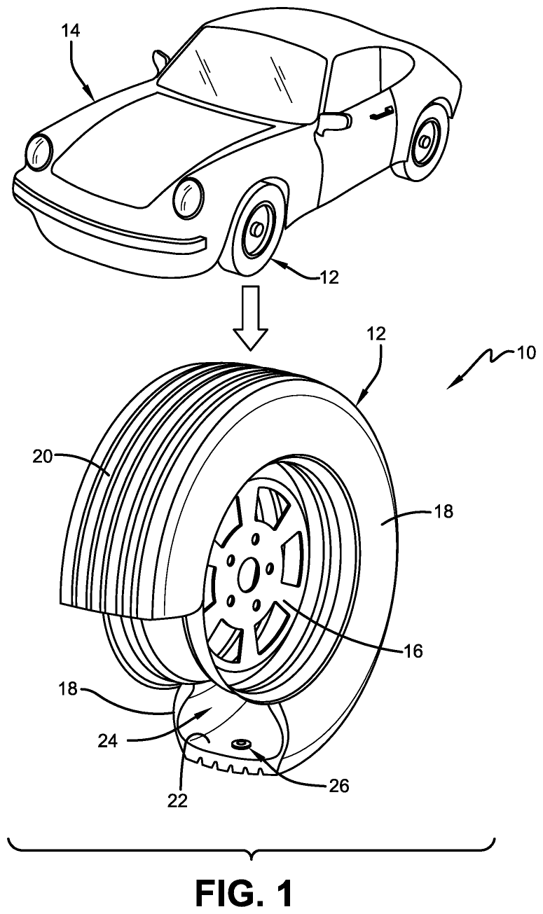

With reference to FIGS. 1 through 9, an exemplary embodiment of the tire rolling resistance estimation system of the present invention is indicated at 10.

With particular reference to FIG. 1, the system 10 estimates the rolling resistance of each tire 12 supporting a vehicle 14. It is to be understood that the vehicle 14 may be any vehicle type, and is shown by way of example as a passenger car. The tires 12 are of conventional construction, and each tire is mounted on a respective wheel 16 as known to those skilled in the art. Each tire 12 includes a pair of sidewalls 18 that extend to a circumferential tread 20, which wears with age from road abrasion. An innerliner 22 is disposed on the inner surface of the tire 12, and when the tire is mounted on the wheel 16, an internal cavity 24 is formed, which is filled with a pressurized fluid, such as air.

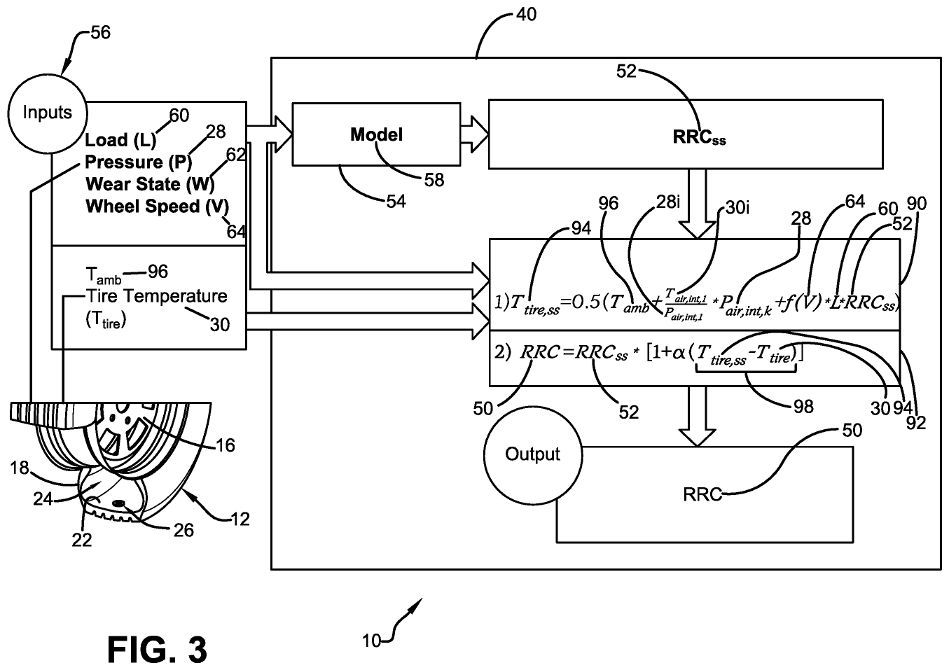

A tire sensor unit 26 is mounted to each tire 12, such as by attachment to the innerliner 22 by means such as an adhesive, and measures certain characteristics of the tire, such as tire inflation pressure 28 (FIG. 3) and tire temperature 30. For this reason, the tire sensor unit 26 preferably includes a pressure sensor and a temperature sensor, and may be of any known configuration, such as a tire pressure management system (TPMS) sensor. The tire sensor unit 26 may also include electronic memory capacity for storing identification (ID) information for each tire 12, known as tire ID information. It is to be understood that the tire sensor unit 26 may be mounted on a component or structure of the tire 12 other than the innerliner 22.

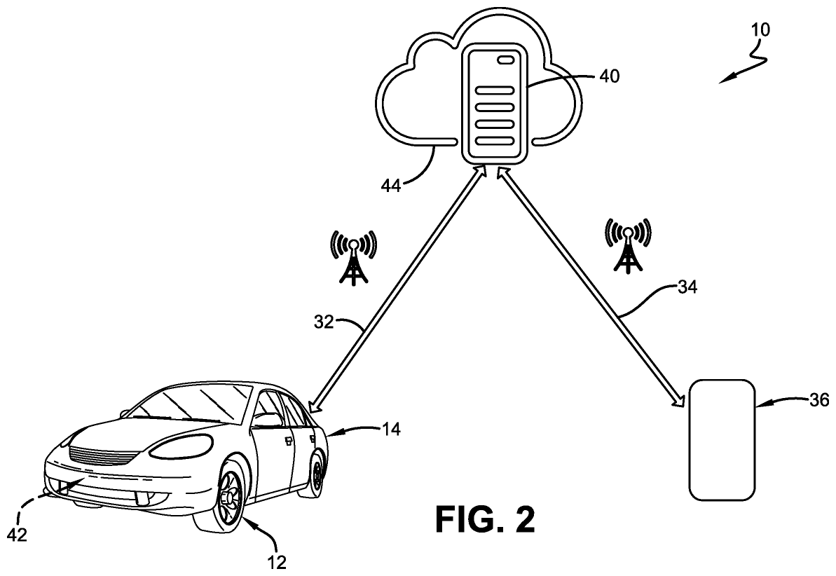

Turning to FIG. 2, aspects of the tire rolling resistance estimation system 10 preferably are executed on a processor 40. The processor 40 enables input of parameters and execution of specific techniques, to be described below, which are stored in a suitable storage medium and are in electronic communication with the processor. The processor 40 may be mounted on the vehicle 14, may be in communication with an electronic control system 42 of the vehicle, such as the vehicle CAN bus system, and/or may be a remote processor in a cloud-based server 44.

Wireless transmission means 32, such as an antenna, may wirelessly send the measured tire pressure 28 and tire temperature 30 from the tire sensor unit 26 (FIG. 1) to the processor 40. Output from the tire rolling resistance estimation system 10 may be wirelessly transmitted by an antenna 34 from the processor 40 to a display or controller device 36 and/or to the electronic control system 42 of the vehicle 14.

Referring to FIG. 3, the tire rolling resistance estimation system 10 provides an estimation of the rolling resistance of the tire 12. Rolling resistance is often expressed as a coefficient multiplied by normal force, and the coefficient is referred to as the rolling resistance coefficient (RRc), indicated at 50. The goal of the system 10 is to predict or estimate an accurate real-time rolling resistance coefficient 50 under transient driving or operating conditions of the tire 12.

In the tire rolling resistance estimation system 10, a steady state rolling resistance coefficient 52 is determined with a steady state coefficient determination module 54. The steady state coefficient determination module 54 preferably employs a regression model 58 with multiple inputs 56. A preferred regression model 58 is a multiple linear regression model, which determines the relationship between multiple independent variables, which are the inputs 56, and one dependent variable, which is the steady state rolling resistance coefficient 52. By way of example, the inputs 56 may include a tire load 60, the tire inflation pressure 28, a wear state 62 of the tire 12, and a rotational or rolling speed of the tire, which is referred to as a wheel speed 64.

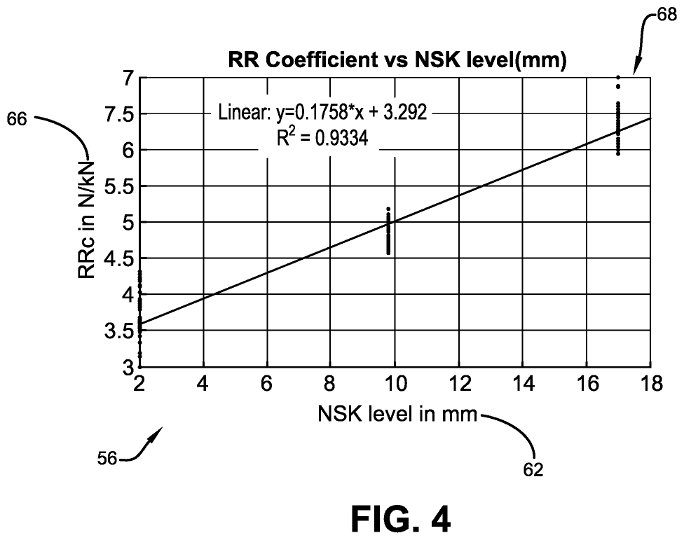

With additional reference to FIG. 4, turning to the input 56 of the tire wear state 62, the tire wear state may be directly measured as an amount of remaining non-skid depth of the tread 20, or may be calculated according to any known method. An exemplary method for the calculation of tire wear state 62 is shown and described in U.S. Published Patent Application Number 2019/0001757, which is owned by the same Assignee as the instant Application, The Goodyear Tire & Rubber Company, and which is incorporated herein in its entirety.

Rolling resistance lab testing or controlled environment testing may be performed to correlate measured or calculated values of the tire wear state 62 to corresponding rolling resistance values 66 in a wear component 68 of the steady state coefficient determination module 54. In this manner, one component of the multiple linear regression model 58 of the steady state coefficient determination module 54 is the wear component 68.

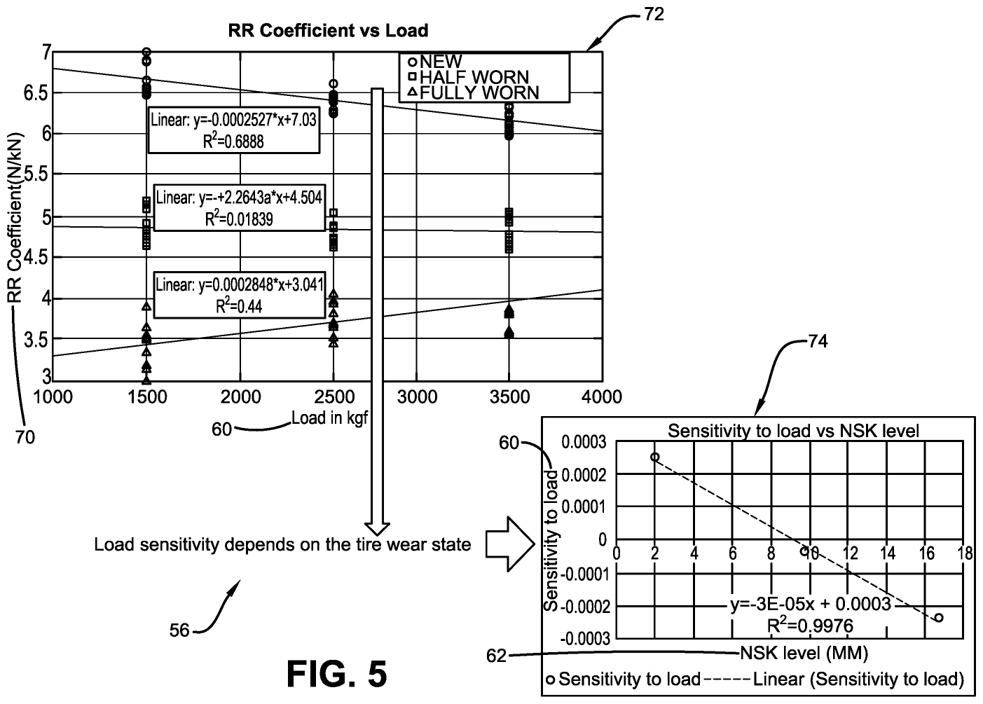

Turning to FIG. 5, for the input 56 of the tire load 60, the calculation of tire load may be performed according to any known method. Exemplary methods for the calculation of tire load 60 are shown and described in U.S. Pat. Nos. 9,120,356 and 10,245,906, both of which are owned by the same Assignee as the instant Application, The Goodyear Tire & Rubber Company, and which are incorporated herein in their entirety.

Rolling resistance lab testing or controlled environment testing may be performed to correlate calculated values of the tire load 60 to corresponding rolling resistance values 70 in a load component 72 of the steady state coefficient determination module 54. Preferably, the tire wear state 62 is taken into consideration in generating the load component 72 due to a correlation 74 between the tire load 60 and the tire wear state. In this manner, another component of the multiple linear regression model 58 of the steady coefficient state determination module 54 is the load component 72.

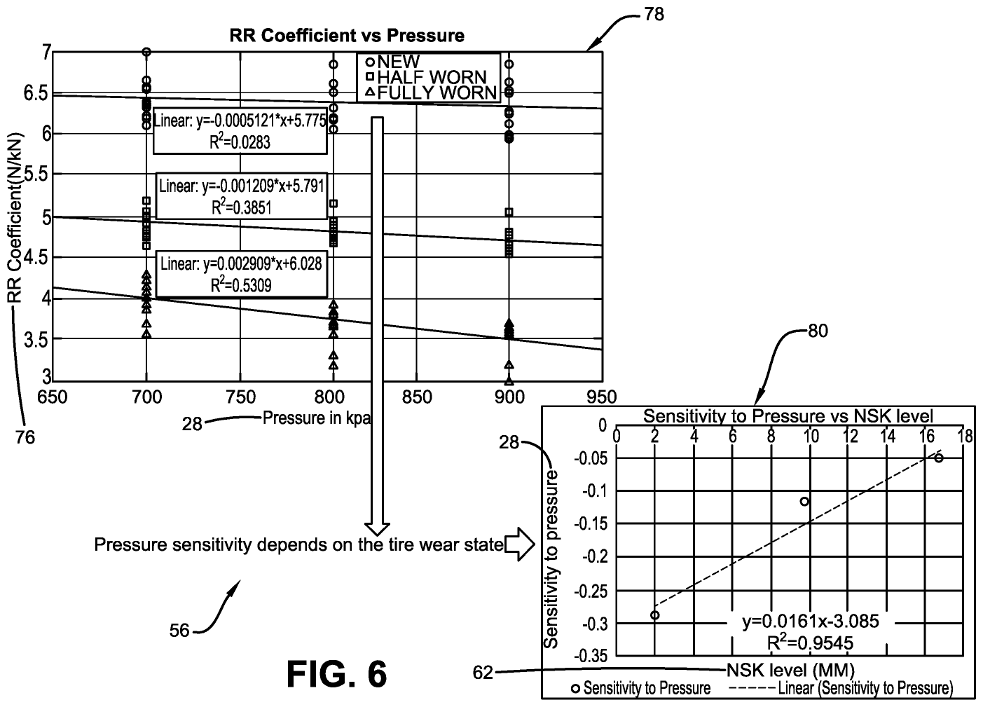

Referring to FIG. 6, for the input 56 of the tire inflation pressure 28, the inflation pressure preferably is provided by the tire sensor unit 26. Rolling resistance lab testing or controlled environment testing may be performed to correlate predetermined values of the tire inflation pressure 28 to corresponding rolling resistance values 76 in a pressure component 78 of the steady state coefficient determination module 54. Preferably, the tire wear state 62 is taken into consideration in generating the pressure component 78 due to a correlation 80 between tire inflation pressure 28 and the tire wear state. In this manner, another component of the multiple linear regression model 58 of the steady state coefficient determination module 54 is the pressure component 78.

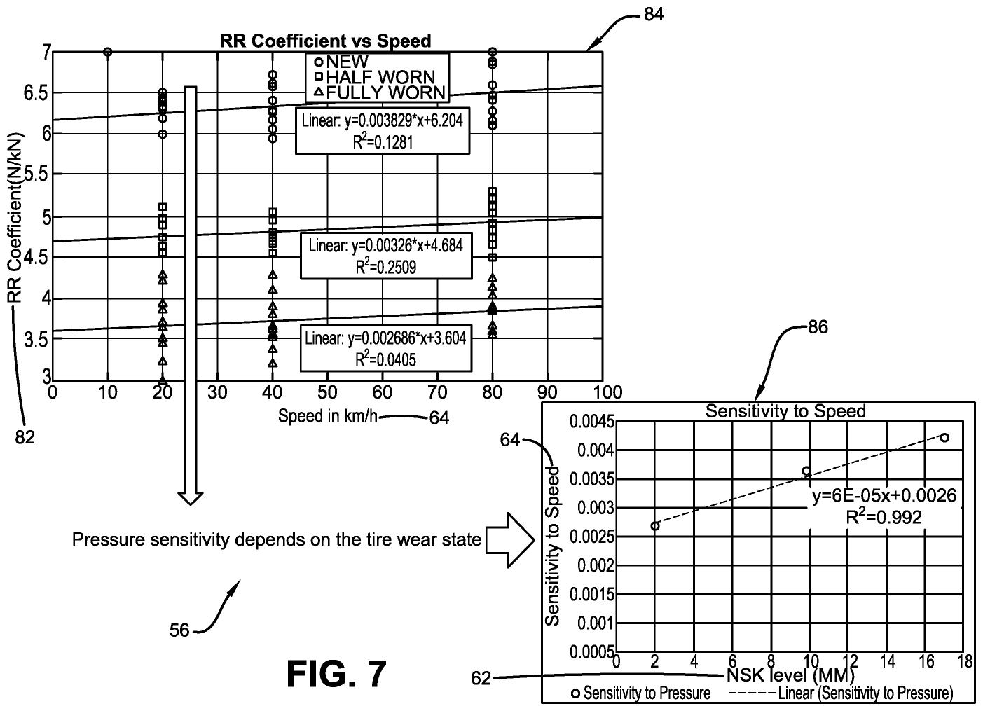

Referring to FIG. 7, for the input 56 of the wheel speed 64, the wheel speed preferably is provided by a tire-mounted, wheel-mounted, or vehicle mounted speed or acceleration sensor unit. Rolling resistance lab testing or controlled environment testing may be performed to correlate predetermined values of the wheel speed 64 to corresponding rolling resistance values 82 in a wheel speed component 84 of the steady state coefficient determination module 54. Preferably, the tire wear state 62 is taken into consideration in generating the wheel speed component 84 due to a correlation 86 between wheel speed 64 and the tire wear state. In this manner, another component of the multiple linear regression model 58 of the steady state coefficient determination module 54 is the wheel speed component 84.

Returning to FIG. 3, the steady state coefficient determination module 54 thus determines the relationship between the independent variables of the tire load 60, the tire inflation pressure 28, the tire wear state 62, and the wheel speed 64, and the dependent variable of the steady state rolling resistance coefficient 52. The relationship is determined by the multiple linear regression model 58, which employs the wear component 68, the load component 72, the pressure component 78, and the wheel speed component 84 to determine the steady state rolling resistance coefficient 52.

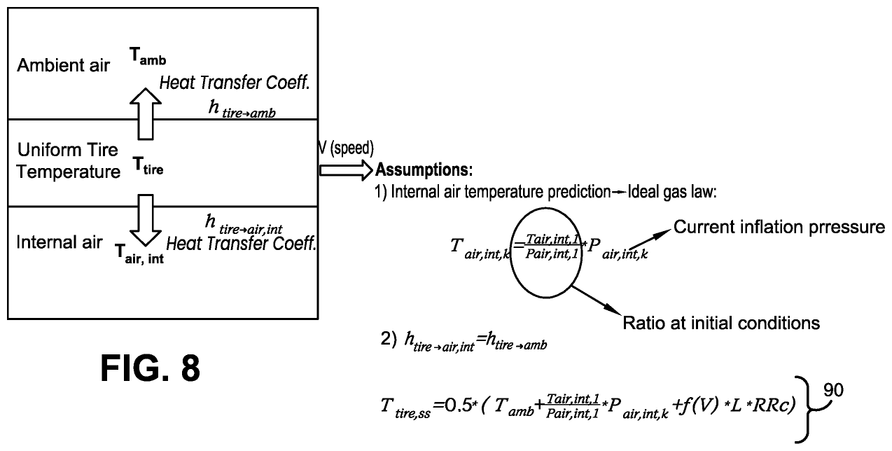

The tire rolling resistance estimation system 10 also includes a steady state tire temperature module 90 and a real-time rolling resistance coefficient module 92. With additional reference to FIG. 8, the steady state tire temperature module 90 employs a combination of data-driven and physics-based approaches to build a semi-empirical model for prediction of a steady state tire temperature 94, as opposed to prior art techniques, which solely employed a physics-based approach.

The steady state tire temperature module 90 estimates the steady state tire temperature 94 based on the expected the steady state rolling resistance coefficient 52 from the steady state coefficient determination module 54, the tire load 60, and the wheel speed 64. The steady state tire temperature module 90 also accounts for an ambient temperature 96, which may be input from a wheel-mounted sensor, a vehicle-mounted temperature sensor, and/or a weather-based service. The steady state tire temperature module 90 further accounts for a ratio of an initial measured tire temperature 30i from the tire sensor unit 26 to an initial measured tire inflation pressure 28i from the tire sensor unit, and a current measured tire inflation pressure 28 from the tire sensor unit. With these inputs, the steady state tire temperature module 90 determines the steady state tire temperature 94.

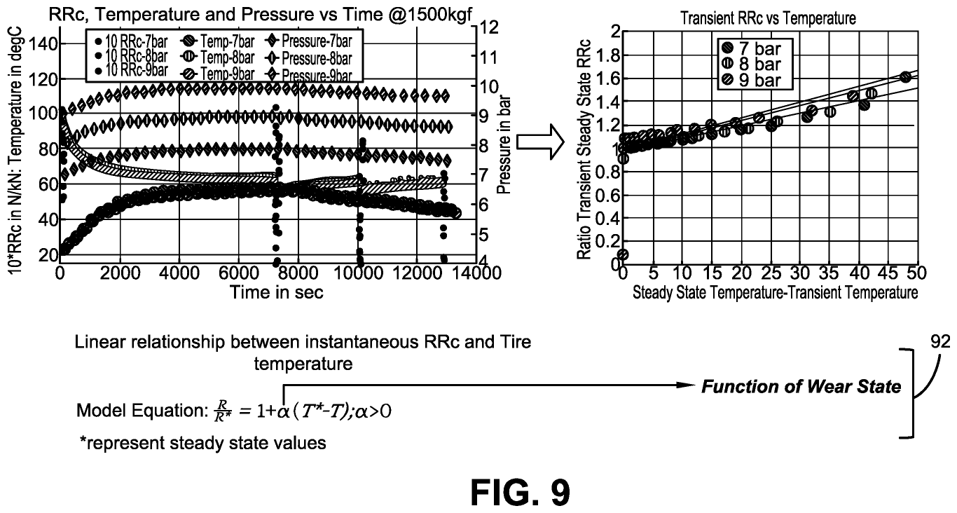

Referring to FIGS. 3 and 9, the real-time rolling resistance coefficient module 92 preferably employs a linear model to estimate the real-time rolling resistance coefficient 50. The estimation of the real-time rolling resistance coefficient 50 is based on the expected the steady state rolling resistance coefficient 52 and a difference 98 between the steady state tire temperature 94 and the current tire temperature 30 from the tire sensor unit 26. The difference 98 between the steady state tire temperature 94 and the current tire temperature 30 indicates how far the tire 12 is from a steady state. To account for the tire wear state 62 in the real-time rolling resistance coefficient module 92, a coefficient a is employed, which is a function of the tire wear state.

The real-time rolling resistance coefficient module 92 thus generates the real-time rolling resistance coefficient 50, which accurately reflects current temperature 30 of the tire 12. As shown in FIG. 2, the rolling resistance coefficient 50 may be wirelessly transmitted by an antenna 34 from the processor 40 to a display or controller device 36 and/or to the electronic control system 42 of the vehicle 14. The rolling resistance coefficient 50 from the tire rolling resistance estimation system 10 may thus be employed by systems that are in electronic communication with the electronic control system 42 of the vehicle 14 to predict the driving range of the vehicle, predict energy loss, and/or provide force allocation determinations.

In this manner, the tire rolling resistance estimation system 10 provides an accurate estimate of the real-time rolling resistance coefficient 50 of the tire 12 under transient driving or operating conditions. The system 10 includes the tire wear state 62 in the determination of the steady state rolling resistance coefficient 52, in the determination of the steady state tire temperature 94, and in the determination of the real-time rolling resistance coefficient 50. The system 10 also includes the tire inflation pressure 28 as an influencing variable in the determination of the steady state tire temperature 94. The system 10 is data-driven, leveraging the measured tire pressure 28 and temperature 30 from the tire sensor unit 26.

The present invention also includes a method for estimating the rolling resistance of a tire. The method includes steps in accordance with the description that is presented above and shown in FIGS. 1 through 9.

It is to be understood that the structure and method of the above-described tire rolling resistance estimation system may be altered or rearranged, or components or steps known to those skilled in the art omitted or added, without affecting the overall concept or operation of the invention. For example, electronic communication may be through a wired connection or wireless communication without affecting the overall concept or operation of the invention. Such wireless communications include radio frequency (RF) and Bluetooth® communications.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A tire rolling resistance estimation system, the system estimating a real-time rolling resistance coefficient of a tire supporting a vehicle, the system including:
a tire sensor unit mounted to the tire, the tire sensor unit measuring an inflation pressure of the tire and a temperature of the tire;
a processor in electronic communication with the tire sensor unit;
a steady state coefficient determination module in electronic communication with the processor, the steady state coefficient determination module receiving a plurality of inputs and determining a steady state rolling resistance coefficient of the tire;
a steady state tire temperature module in electronic communication with the processor, the steady state tire temperature module receiving the steady state rolling resistance coefficient of the tire from the steady state coefficient determination module and estimating a steady state tire temperature of the tire; and
a real-time rolling resistance coefficient module in electronic communication with the processor, the real-time rolling resistance coefficient module receiving the steady state tire temperature of the tire from the steady state tire temperature module and estimating a real-time rolling resistance coefficient of the tire from the steady state rolling resistance coefficient and a difference between the steady state tire temperature and a current tire temperature from the tire sensor unit.

2. The tire rolling resistance estimation system of claim 1, wherein the real-time rolling resistance coefficient is the coefficient under transient operating conditions of the tire.

3. The tire rolling resistance estimation system of claim 1, wherein the steady state coefficient determination module employs a regression model.

4. The tire rolling resistance estimation system of claim 3, wherein the regression model includes a multiple linear regression model.

5. The tire rolling resistance estimation system of claim 1, wherein the plurality of inputs include at least one of a tire load, an inflation pressure of the tire, a wear state of the tire, and a wheel speed of the tire.

6. The tire rolling resistance estimation system of claim 5, wherein the steady state coefficient determination module includes a wear component, the wear component correlating values of the wear state of the tire to corresponding rolling resistance values.

7. The tire rolling resistance estimation system of claim 5, wherein the steady state coefficient determination module includes a load component, the load component correlating values of the tire load to corresponding rolling resistance values.

8. The tire rolling resistance estimation system of claim 7, wherein the load component accounts for the wear state of the tire.

9. The tire rolling resistance estimation system of claim 5, wherein the steady state coefficient determination module includes a pressure component, the pressure component correlating values of the tire inflation pressure to corresponding rolling resistance values.

10. The tire rolling resistance estimation system of claim 9, wherein the pressure component accounts for the wear state of the tire.

11. The tire rolling resistance estimation system of claim 5, wherein the steady state coefficient determination module includes a wheel speed component, the wheel speed component correlating values of the wheel speed to corresponding rolling resistance values.

12. The tire rolling resistance estimation system of claim 11, wherein the wheel speed component accounts for the wear state of the tire.

13. The tire rolling resistance estimation system of claim 1, wherein the steady state tire temperature module estimates the steady state tire temperature based on the steady state rolling resistance coefficient of the tire, a tire load, and a wheel speed of the tire.

14. The tire rolling resistance estimation system of claim 13, wherein the steady state tire temperature module accounts for an ambient temperature.

15. The tire rolling resistance estimation system of claim 13, wherein the steady state tire temperature module accounts for a ratio of an initial measured tire temperature from the tire sensor unit to an initial measured tire inflation pressure from the tire sensor unit.

16. The tire rolling resistance estimation system of claim 13, wherein the steady state tire temperature module accounts for a current measured tire inflation pressure from the tire sensor unit.

17. The tire rolling resistance estimation system of claim 1, wherein the real-time rolling resistance coefficient module includes a linear model.

18. The tire rolling resistance estimation system of claim 1, wherein the real-time rolling resistance coefficient module employs a function of the tire wear state.
